(19) United States
(12) Patent Application Publication
(10) Pub. No.: US 2013/0182783 A1
(43) Pub. Date: Jul. 18, 2013

(54) METHOD FOR SERIAL DATA TRANSMISSION

(71) Applicant: Peter Jänicke, Erlangen (DE)

(72) Inventor: Peter Jänicke, Erlangen (DE)

(73) Assignee: Siemens Aktiengesellschaft, Munchen (DE)

(21) Appl. No.: 13/469,365

(22) Filed: May 11, 2012

(30) Foreign Application Priority Data
May 13, 2011 (EP) EP11165972.8

(51) Int. Cl. H04L 27/00

(52) U.S. Cl. CPC H04L 27/00
USPC 375/259

(57) ABSTRACT

A method for serial transmission of data in form of telegrams and symbols between at least one sender and at least one receiver, includes converting on the sender side an item of data into a symbol, converting on the receiver side the symbol into an item of data, identifying a telegram with special symbols, transmitting at least one first and one second pause symbol different from the special symbols for encoding a pause between telegrams, and deriving information from a sequence of the pause symbols.

### CROSS-REFERENCES TO RELATED APPLICATIONS

This application claims the priority of European Patent Application EP11165972.8 filed 13. May 2011, pursuant to 35 U.S.C. 119(a)-(d), the content of which is incorporated herein by reference in its entirety as if fully set forth herein.

### BACKGROUND OF THE INVENTION

The present invention relates to a method for serial transmission of data between at least one sender and at least one receiver.

The following discussion of related art is provided to assist the reader in understanding the advantages of the invention, and is not to be construed as an admission that this related art is prior art to this invention.

Serial data transmission methods are known in the art. Frequently, however, the necessity arises as well as sending the transmitted data, which will also be referred to as payload data below by way of distinction, to be able to send additional data. Such additional data is referred to in technical terminology as sideband data, by way of distinguishing it from other data. Sideband data can be used for diagnostic purposes, to encode a communication link quality, etc.

Two approaches have previously been considered for the transmission of sideband data. On the one hand, separate interfaces or interfaces with additional lines are used. However in a disadvantageous manner this increases the costs of the communication link between two or more communication users. On the other hand, consideration has also been given to packing the sideband data into telegrams transferred during data transmission between two communication users and normally only containing payload data or appending it to such telegrams. However the definition of the payload data telegrams must be modified or expanded for this purpose. In addition the transmission of sideband data in payload data telegrams requires the transfer of payload data telegrams to be functioning. This can however be a significant disadvantage in the transmission of diagnostic information in the sideband data for example. In addition appending sideband data to a payload data telegram reduces the amount of payload data able to be transmitted in a unit of time.

It would therefore be desirable and advantageous to obviate prior art shortcomings and to provide an improved method for the transmission of sideband data.

### SUMMARY OF THE INVENTION

According to one aspect of the present invention, a method for serial transmission of data in form of telegrams and symbols between at least one sender and at least one receiver, includes the steps of converting on the sender side an item of data into a symbol, converting on the receiver side the symbol into an item of data, identifying a telegram with special symbols, transmitting at least one first and one second pause symbol different from the special symbols for encoding a pause between telegrams, and deriving information from a sequence of the pause symbols.

According to another aspect of the invention, an automation device in a communication system connecting at least two automation devices via a serial link, includes means for converting on a sender side of the at least two automation devices an item of data into a symbol, means for converting on the receiver side of the at least two automation devices the symbol into an item of data, means for identifying a telegram with special symbols, means for transmitting at least one first and one second pause symbol different from the special symbols for encoding a pause between telegrams, and means for deriving information from a sequence of the pause symbols.

The received sideband data is the derived information or refers back to the derived information. The sideband data on the sender side to be transferred are encoded by pause symbols. To this end, a definition of the symbols provided for serial data transmission is expanded. In transmission, telegram or send pauses—referred to overall as a pause or transmission pause—modern serial data transmission protocols send a pause symbol provided to identify such pauses and for synchronizing the communication users, which is also referred to in specialist terminology as an idle symbol. The approach proposed here makes provision for a first and a second pause symbol to be used instead of the previous individual pause symbols. With respect of the identification of the transmission, pause and/or for synchronization all pause symbols, i.e. at least the first and second pause symbol, are evaluated by the serial data transmission protocol like the previous individual pause symbol. For transmission, sideband data are encoded as a sequence of pause symbols. The pause symbols or also a transition between pause symbols are thus now given information content.

Advantageously, symbols which are typically sent in the transmission pauses in modern serial data transmission protocols are used to transfer the sideband data, so that, with the approach proposed here, the transmission of the sideband data is possible without loss of bandwidth. In addition the sideband data can be transmitted without physical modification of the interface, such as additional lines or the like, so that the approach proposed here can be used at low cost and can easily be used for existing communication systems.

In respect of the derivation of information from a sequence of pause symbols, each pause symbol may be assigned a status value, i.e. for two pause symbols for example “0” or “1”, “high” or “low”, and the information is produced from the sequence of the resulting status values.

According to another advantageous feature of the present invention, a status value may be assigned to a transition between a pause symbol and another pause symbol, especially a transition between the first and the second pause symbol and the second and the first pause symbol, i.e. “0” or “1 “,” high” or “low” for example, and the information is again produced from the sequence of the resulting status values. If a transition is also detected from one pause symbol to a next identical pause symbol, four possible transitions are produced, with two pause symbols to which a separate status value can be assigned in each case, i.e. “00”, “01”, “10” and “11” for example.

Advantageously, instead of two pause symbols, more than two pause symbols may be used, with four pause symbols a consideration is for example to assign the first second third and fourth pause symbols then produces the following status values in binary notation: “00”, “01”, “10” and “11”. When the status value is encoded by the transition between two pause symbols, 16 possible transitions are already produced for four pause symbols and thereby sixteen different status values. If only transitions between different pause symbols are to encode a permitted status value, twelve different status values are still produced for four pause symbols.

According to another advantageous feature of the present invention, the symbol may be converted into an item of data by a so-called 4B/5B encoding. 4B/5B encoding is a largely direct-current-free encoding. In addition, it is also ensured that sufficient flank changes are present in the signal in order to make clock recovery possible. Alternatively, for converting a symbol into a data item, a so-called 8B/10B encoding or generally any encoding operating with symbols may be used, wherein 8B/10B encoding, as well as the properties of 4B/5B encoding, also has the property of being direct current-free. 8B/10B is widespread and is used for example in USB2.0, USB3.0, Firewire800; PCIe 1.x and 2.x, DVI, etc. further encoding processes operating with symbols and thus to be considered are especially 64b/66b (10 Gbit-Ethernet), 128b/130b (PCIe 3.0) and Eight-to-Fourteen (Compact Disc).

According to another advantageous feature of the present invention, the method may be implemented in software or in software and firmware. The invention also relates to a computer program with program code instructions able to be executed by a computer for implementing the method and on the other hand a storage medium with such a computer program and finally also an automation device, in the memory of which or in the hardware provided therefor, e.g. in the form of an ASIC, as a means for executing the method and its embodiments, such a computer program is loaded or is able to be loaded. The method can also be implemented in hardware, e.g. in the form of an interface component expanded by a functionality in accordance with the method proposed here for a serial link. The invention is thus also such an interface component or an automation device with such an interface component. A controller, e.g. a programmable logic controller or a decentralized peripheral device, a sensor or an actuator, a drive control device, etc. are considered as an automation device. Accordingly, the term automation device should include all devices, components or systems, i.e. as well as for example controls such as programmable logic controls, process computers, (industry) computers and the like, also drive controllers, frequency converters and suchlike, as are used or can be used for open-loop, closed-loop control and/or monitoring of technological processes, e.g. for reshaping or transporting material, energy or information, etc., wherein energy is especially applied to or converted through suitable technical facilities such as sensors or actuators for example.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows an automation system, in which at least individual automation devices are linked for communication by a serial link;

FIG. 2 shows a section from a data transmission over a serial link between a sender and a receiver with a telegram extract and another telegram following after a transmission pause according to the present invention;

FIG. 3 shows a section in accordance with FIG. 2, wherein, for transmission of data during the telegram pause and if necessary further telegram pauses, at least one first and one second symbol encoding a pause is transmitted and wherein information is derived from a sequence of this type of pause symbols according to the present invention; and

FIG. 4 shows a sender and receiver connected for communication via a serial link, with a communication component configured for implementing the method.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

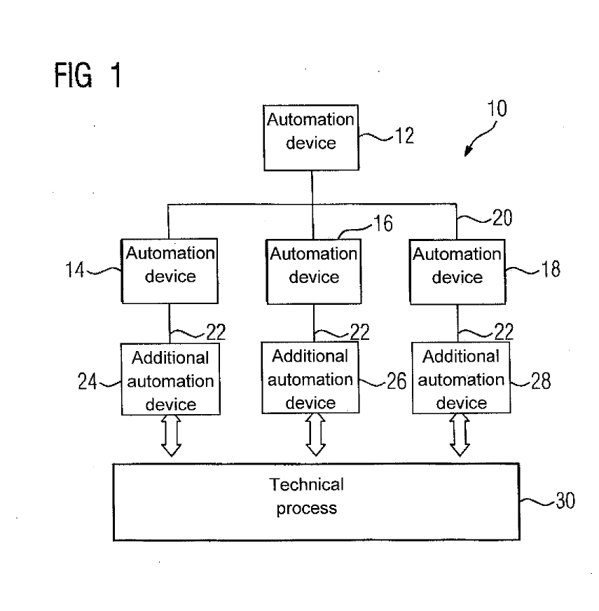

Turning now to the drawing, and in particular to FIG. 1, there is shown a schematic simplified diagram of an automation system 10 with a plurality of automation devices 12, 14, 16, 18, of which one functions as a higher-ranking unit 12 for example. The automation devices 12, 14, 16, 18 can involve programmable logic controls, decentralized peripheral devices, drive controllers, etc. The automation devices are linked for communication in a known manner, e.g. by a bus, especially a field bus 20.

Additional automation devices 24, 26, 28 are linked to individual automation devices 14, 16, 18 via a serial link 22, wherein a field bus 20 can also be basically embodied as a serial link with serial data transmission. The serial link 22 shown should thus expressly only serve as an example of a possible serial link in an automation system 10. The additional automation devices, in the configuration shown in FIG. 1, involve so-called intelligent sensors or actuators for example, which exchange data over the serial link 22. The automation system 10 is intended overall for control and/or monitoring an industrial technical process 30 not shown in the figure, in that sensors for example pick up data from the technical process 30, forward it for processing to one of the automation devices 12-18 where, on the basis of a state of the technical process 30 recorded in this way, control commands are determined for the technical process 30, which are transferred to actuators for influencing the technical process 30.

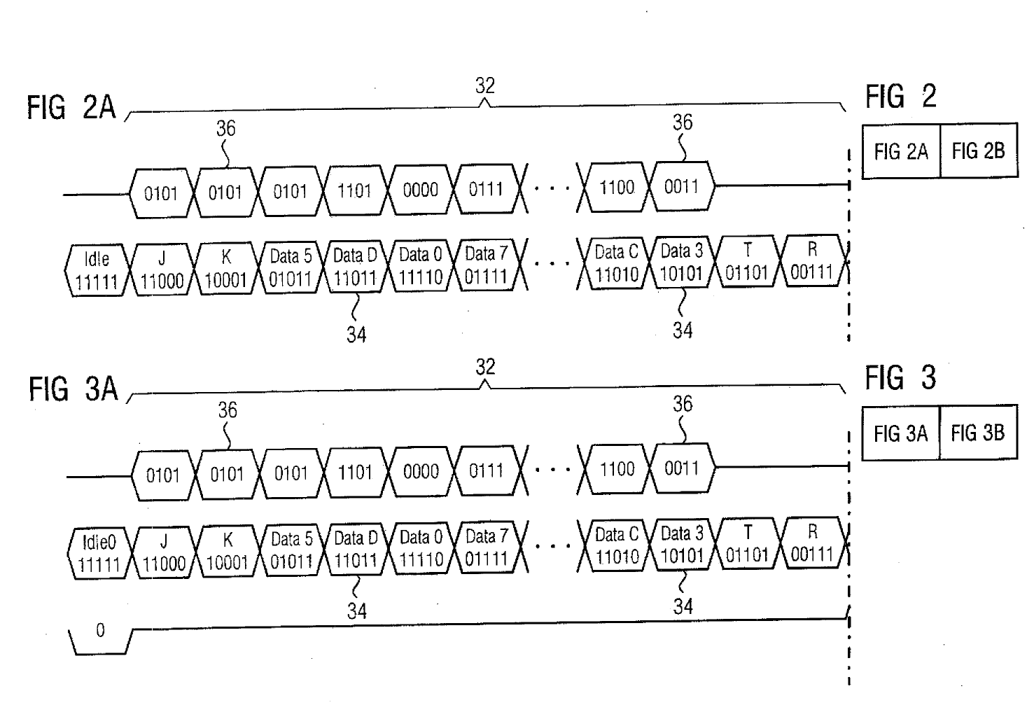

FIG. 2 shows a section from a telegram 32 in a data transmission over a serial link 22 (FIG. 1) and in fact shows it as an example of so-called 4B/5B encoding. In such an encoding or a similar encoding, symbols 34 are transmitted and the transmitted symbols 34 are each converted into a data item 36. In order not to unnecessarily make the figure more difficult to understand, only single symbols 34 and data 36 are identified by the reference number. In the 4B/5B encoding depicted, each symbol 34 comprises five bits and each item of data 36 four bits; this is also called four payload data bits and five code bits. Shown in Table 1 at the end of the document is 4B/5B encoding with further symbols 34 and the respective associated item of data 36. Special symbols 34 identify a telegram 32, namely its start and its end.

During sending, a sender, namely one of the automation devices 14-18, creates a telegram frame with the special symbols 34 “J” and “K” to identify the beginning of the telegram and later the special symbols 34 “T” and “R” to identify the end of the telegram and in between, as payload data of the telegram 32 for each item of data 36 to be transmitted, the associated symbol 34 (payload data symbol). A receiver of such a telegram 32 recognizes the beginning and the end of the telegram 32 from the special symbols 34, namely “J” and “K” or “T” and “R”, and converts the symbols 34 (payload data symbols) included in the telegram 32 into an item of data 36 in each case. Transmitted in between two telegrams 32 are special symbols 36 encoding a pause (transmission pause) which are referred to below as pause symbols 38. The transmission of a number of pause symbols 38 in a send or receive pause is usual. In the Fast Ethernet Standard IEEE802.3, for example, a number of twenty-two pause symbols 38 between two telegrams 32 is defined. As with the symbols 34 and the respective associated item of data 36, in FIG. 2 with regard to clarity only individual pause symbols 38 are labeled with the reference number. A pause symbol 38 is also referred to in specialist terminology as an idle symbol or just as an idle. This designation is shown in the drawing as the meaning of the symbol.

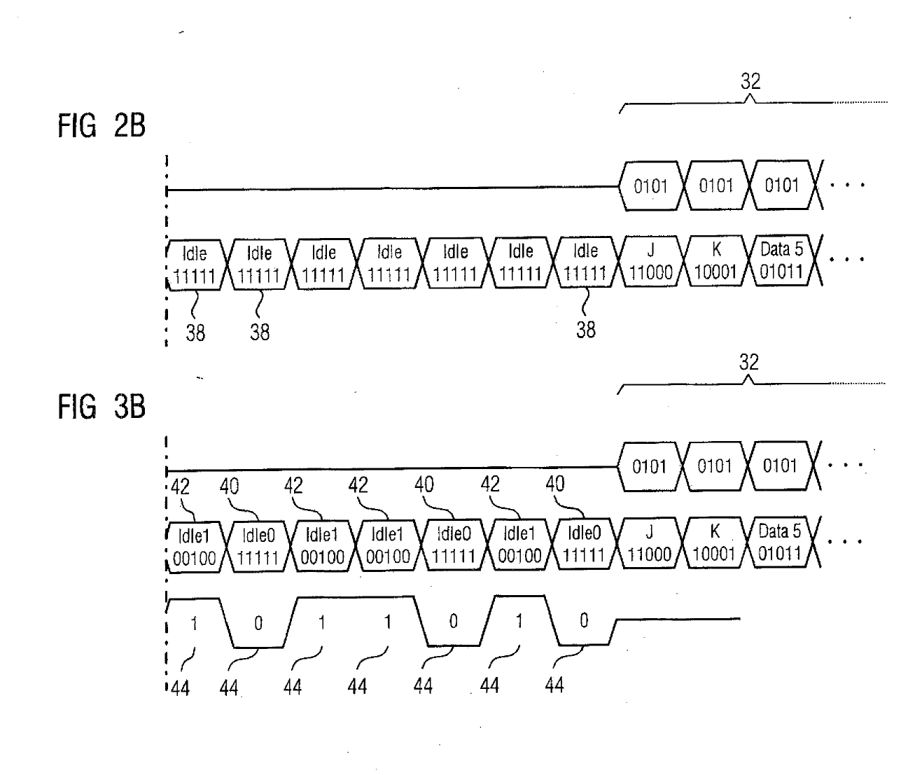

FIG. 3 essentially shows the situation as in FIG. 2. In addition it is also shown that, for transmission of data during the telegram pauses at least one first and one second symbol encoding a pause—first and second pause symbol 40, 42—is transmitted and that information is derived from a sequence of pause symbols 40, 42. Table 2 appended to this description also shows the expanded 4B/5B encoding, with basically any other encoding, i.e. for example 8B/10B, also being considered. The information derived from the sequence of pause symbols 40, 42 is referred to here as sideband data because it is transferred in the transmission pauses, i.e. in the periods in which no payload data is transmitted. Instead of the situation shown in FIG. 3 to explain the principle of the approach proposed here, in which a pause symbol 40, 42 is converted directly into an item of sideband data 44, for example a first pause symbol 40 into a logical “0” as sideband data 44 a second pause symbol 42 into a logical “1” as further sideband data 44, consideration is also given to transitions between pause symbols 40, 42 encoding an item of sideband data.

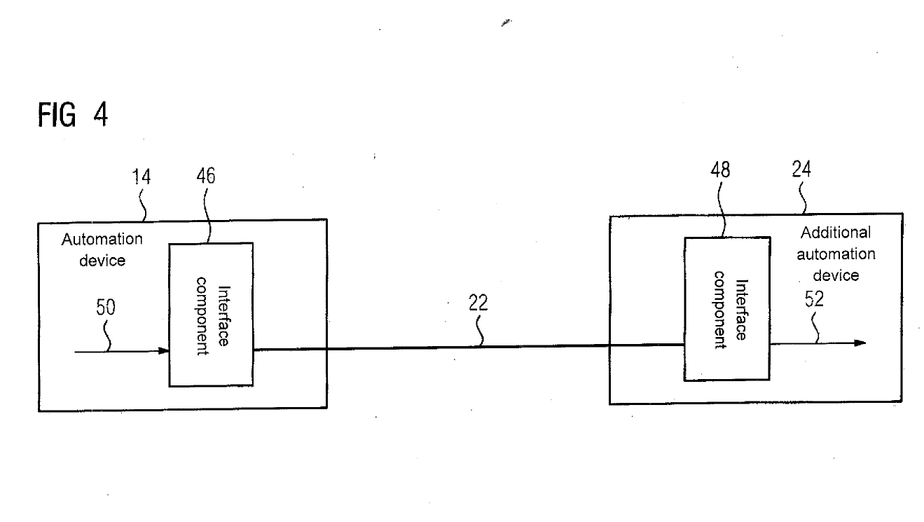

FIG. 4 finally shows on the left-hand side an automation device 12-18, 24-28 (FIG. 1) as a sender and on the right-hand side an automation device 12-18, 24-28 as a receiver during a serial data transmission over a serial link 22. Each automation device 12-18, 24-28 can in this case—depending on the communication direction—function both as a sender and also as a receiver. As well as the automation devices mentioned here, other electrical or electronic devices in which a serial networking is provided or is sensible are also basically considered as senders and receivers, e.g. devices as are used in office automation or devices or functional units in a motor vehicle, aircraft, etc. Modern links such as Ethernet, USB, Firewire, CAN-Bus, RS-485, etc. are also deemed to be serial links 22 within the meaning of the terminology used here, even if these are usually not primarily designated as serial links or serial interfaces.

To implement the method each device connected to a serial link 22 has an interface component 46, 48, or the functionality of such an interface component 46, 48 integrated into another functional unit, especially a semiconductor component. An example of such an interface component 46, 48 is the interface component known by the abbreviation UART. Such an interface component 46, 48 is a possible location for implementing the method, namely for transmission of data wherein, during the telegram pauses, at least one first and one second symbol 40, 42 encoding a pause is transmitted, and for deriving information from a sequence of such pause symbols 40, 42. The generation and transmission of the pause symbols 40, 42 in accordance with the information to be transferred as sideband data 44, e.g. diagnostic information, is undertaken in this case by the respective sender. The derivation of information from a sequence of such pause symbols 40, 42, i.e. an indirect or direct derivation of the respective sideband data 44, is undertaken by the respective receiver. For this purpose the respective interface component 46 of the sender receives input signals 50 in respect of the information to be transmitted as sideband data 44 and the respective interface component 48 of the receiver makes available the received sideband data 44 as output signals 52. Not shown in the figure in this case is that the respective interface component 46, 48 on the sender side also receives input signals in respect of the payload data to be transferred and on the receiver side on the basis of the received payload data generates output signals relating to said data.

An interface component 46, 48 as shown in FIG. 4, is an example of means for executing the method proposed here and if necessary individual embodiments thereof, namely for transmitting at least one first and second pause symbol 40, 42 during telegram pauses and for deriving information from a sequence of pause symbols 40, 42. Where the method is implemented in software, in a manner not shown but known per se, a computer program with program code instructions is the means for executing the method, wherein the computer program is able to be loaded into a processing unit by nature of a microprocessor which provides the functionality of an interface component 46, 48. Where the method is implemented in software and firmware or only in firmware, for example in the case of an ASIC, FPGA, etc., to realize the functionality of the interface component 46, 48, the term computer program also means a functionality expressed in a hardware description language of the firmware which, for the purposes of configuration of the interface component 46, 48, is transmitted into the latter.

Individual aspects of the description given here can thus be summarized briefly as follows: A method is specified as serial transmission of data between the at least one sender and at least one receiver, wherein the data transmission is undertaken in the form of telegrams 32 and with symbols 34, by an item of data 36 being converted into a symbol 34 on the sender side and the symbol 34 being converted into an item of data 36 on the receiver side wherein, to identify a telegram 32, special symbols 34 are used and wherein, in telegram pauses, a symbol 38, 40, 42 encoding a pause is transmitted, wherein the method is characterized in particular by the fact that for transmission of data during the telegram pauses at least one first in one second symbol encoding a pause—first and second pause symbol 40, 42—is transmitted and that information is derived from a sequence of pause symbols 40, 42.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

TABLE 1

| Code group | Data item | Interpretation |
|---|---|---|
| 11110 | 0000 | Data0 |
| 01001 | 0001 | Data1 |
| 10100 | 0010 | Data2 |
| 10101 | 0011 | Data3 |
| 01010 | 0100 | Data4 |
| 01011 | 0101 | Data5 |
| 01110 | 0110 | Data6 |
| 01111 | 0111 | Data7 |
| 10010 | 1000 | Data8 |
| 10011 | 1001 | Data9 |
| 10110 | 1010 | DataA |
| 10111 | 1011 | DataB |
| 11010 | 1100 | DataC |
| 11011 | 1101 | DataD |
| 11100 | 1110 | DataE |
| 11101 | 1111 | DataF |
| 11111 | ./. | Idle |
| | | (pause symbol) |
| 11000 | ./. | J |
| 10001 | ./. | K |
| 01101 | ./. | T |
| 00111 | ./. | R |
| 00000 | | Not used |
| 00001 | | Not used |
| 00010 | | Not used |
| 00011 | | Not used |
| 00100 | | Not used |
| 00101 | | Not used |
| 00110 | | Not used |
| 01000 | | Not used |
| 01100 | | Not used |
| 10000 | | Not used |
| 11001 | | Not used |

TABLE 2

| Code group | Data item | Interpretation |
|---|---|---|
| 11110 | 0000 | Data0 |
| 01001 | 0001 | Data1 |
| 10100 | 0010 | Data2 |
| 10101 | 0011 | Data3 |
| 01010 | 0100 | Data4 |
| 01011 | 0101 | Data5 |
| 01110 | 0110 | Data6 |
| 01111 | 0111 | Data7 |
| 10010 | 1000 | Data8 |
| 10011 | 1001 | Data9 |
| 10110 | 1010 | DataA |
| 10111 | 1011 | DataB |
| 11010 | 1100 | DataC |
| 11011 | 1101 | DataD |
| 11100 | 1110 | DataE |
| 11101 | 1111 | DataF |
| 11111 | ./. | Idle 1 (first pause |
| | | symbol) |
| 11000 | ./. | J |
| 10001 | ./. | K |
| 01101 | ./. | T |
| 00111 | ./. | R |
| 00100 | | Idle 2 (second |
| | | pause symbol) |
| 00000 | | not used |
| 00001 | | Not used |
| 00010 | | Not used |
| 00011 | | Not used |
| 00101 | | Not used |
| 00110 | | Not used |
| 01000 | | Not used |
| 01100 | | Not used |
| 10000 | | Not used |
| 11001 | | Not used |

What is claimed is:

1. A method for serial transmission of data in form of telegrams and symbols between at least one sender and at least one receiver, comprising the steps of:
converting on the sender side an item of data into a symbol,
converting on the receiver side the symbol into an item of data,
identifying a telegram with special symbols,
transmitting at least one first and one second pause symbol different from the special symbols for encoding a pause between telegrams, and
deriving information from a sequence of the pause symbols.

2. The method of claim 1, further comprising the steps of assigning a status value to each pause symbol, and producing the information from a sequence of assigned status values.

3. The method of claim 1, further comprising the steps of assigning a status value to a transition between a first pause symbol and a second pause symbol, and producing the information from a sequence of the assigned status values.

4. The method of claim 1, wherein a symbol is converted into an item of data based on 4B/5B encoding.

5. The method of claim 1, wherein a symbol is converted into an item of data based on 8B/10B encoding.

6. An automation device in a communication system connecting at least two automation devices via a serial link, comprising:
a first interface component disposed in one of the at least two automation devices configured for converting an item of data into a symbol and sending a telegram containing the symbol and special symbols,
a second interface component disposed in another of the at least two automation devices receiving the symbol and configured for converting the symbol into an item of data and identifying the special symbols, and
wherein the first and second interface components are configured for transmitting at least one first and one second pause symbol different from the special symbols for encoding a pause between telegrams and for deriving information from a sequence of the pause symbols.

7. A computer program embodied in a non-transitory medium and comprising program code instructions for serial transmission of data in form of telegrams and symbols between at least one sender and at least one receiver, wherein the program code instructions, when executed on an automation device, cause the automation device to
convert on the sender side an item of data into a symbol, and
convert on the receiver side the symbol into an item of data,
identify a telegram with special symbols,
transmit at least one first and one second pause symbol different from the special symbols for encoding a pause between telegrams, and
derive information from a sequence of the pause symbols.

8. The automation device of claim 6, comprising a computer program embodied in a non-transitory medium and comprising program code instructions for serial transmission of data in form of telegrams and symbols between at least one sender and at least one receiver, wherein the program code instructions, when executed on the automation device, cause the automation device to
convert on the sender side an item of data into a symbol, and
convert on the receiver side the symbol into an item of data,
identify a telegram with special symbols,
transmit at least one first and one second pause symbol different from the special symbols for encoding a pause between telegrams, and
derive information from a sequence of the pause symbols.

9. A non-transitory storage medium comprising a computer program with program code instructions for serial transmission of data in form of telegrams and symbols between at least one sender and at least one receiver, wherein the program code instructions, when executed on an automation device, cause the automation device to
convert on the sender side an item of data into a symbol, and
convert on the receiver side the symbol into an item of data,
identify a telegram with special symbols,
transmit at least one first and one second pause symbol different from the special symbols for encoding a pause between telegrams, and
derive information from a sequence of the pause symbols.
